(19) United States
(12) Patent Application Publication
(10) Pub. No.: US 2011/0217104 A1
(43) Pub. Date: Sep. 8, 2011

(54) PARRYING STRUCTURE AROUND SHEET JUNCTION

(75) Inventor: Sadahiro Masuda, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 13/036,835

(22) Filed: Feb. 28, 2011

Related U.S. Application Data
(60) Provisional application No. 61/310,173, filed on Mar. 3, 2010.

(51) Int. Cl. G03G 15/00; B65H 9/00; B65H 5/02

(52) U.S. Cl. 399/388; 271/243; 271/3.18

(57) ABSTRACT

According to one embodiment, a parrying structure around sheet junction including a first transporting guide that guides a sheet medium, a second transporting guide that guides the sheet medium toward the first transporting guide at a larger angle than a predetermined angle with respect to a direction where the sheet medium is guided by the first transporting guide, and a third transporting guide that guides a leading edge of the sheet medium, which is guided by the second transporting guide and moved to the first transporting guide, toward the first transporting guide.

### CROSS-REFERENCE TO RELATED APPLICATIONS

This application is based upon and claims the benefit of priority from: U.S. Provisional Application No. 61/310,173 filed on Mar. 3, 2010, the entire contents of each of which are incorporated herein reference.

### FILED

Embodiments described herein relates generally to an image forming apparatus and parrying structure around a junction for sheet medium.

### BACKGROUND

A toner (a visualizing agent) moves to a sheet medium on the basis of image information and is integrated with the sheet medium. The sheet medium (integrated with the toner) is a hard copy.

In a case when, the thickness of the sheet medium is thick, the sheet medium is jammed in a junction for the sheet medium.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary diagram showing an example of an MFP, according to an embodiment;

FIG. 2 is an exemplary diagram showing an example of the MFP, according to an embodiment;

FIG. 3 is an exemplary diagram showing an example of a sheet path of the MFP according to an embodiment;

FIG. 4 is an exemplary diagram showing an example of the sheet path of the MFP according to an embodiment;

FIG. 5 is an exemplary diagram showing an example of a sheet path of the MFP according to an embodiment;

FIG. 6 is an exemplary diagram showing an example of a sheet path of the MFP according to an embodiment; and

FIG. 7 is an exemplary diagram showing an example of a sheet path of the MFP according to an embodiment.

### DETAILED DESCRIPTION

In general, according to an embodiment, a parrying structure around sheet junction comprising: a first transporting guide that guides a sheet medium; a second transporting guide that guides the sheet medium toward the first transporting guide at a larger angle than a predetermined angle with respect to a direction where the sheet medium is guided by the first transporting guide; and a third transporting guide that guides a leading edge of the sheet medium, which is guided by the second transporting guide and moved to the first transporting guide, toward the first transporting guide.

Embodiments will now be described hereinafter in detail with reference to the accompanying drawings.

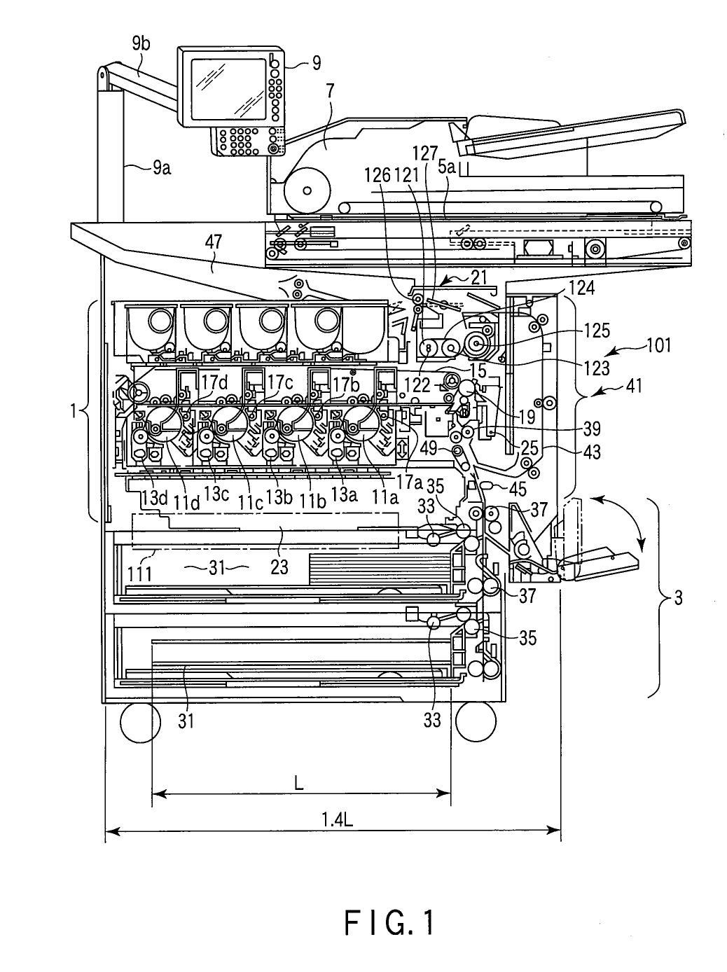

FIG. 1 schematically shows an MFP (Multi-Functional Peripheral) to which the embodiment is able to apply.

An MFP 101 shown in FIG. 1 has an image forming section (a printer section) 1 for outputting image information as an output image which is referred to as a hard copy or a print out, a sheet feeder 3 to supply a sheet medium having an optional size, which is used for an image output, to the image forming section 1, and a scanner section 5 to provide image data of an original to the image forming section 1.

Moreover, the scanner section 5 integrally has an automatically-document feeder (ADF) 7 the original to a reading position on the scanner section 5.

A control panel 9 for giving an instruction for starting image formation in the image forming section 1 and starting to read image information of the original through the scanner section 5 is placed in a strut 9a fixed to the image forming section 1 and a swing arm 9b in a corner at a left or right side behind the scanner section 5.

The image forming section 1 includes first to fourth photoconductive drums 11a to 11d for holding latent images, developers 13a to 13d for supplying a toner to the latent images on the photoconductive drums 11a to 11d to develop toner images, a transfer belt 15 for holding the toner images transferred from the photoconductive drums 11a to 11d in order, cleaners 17a to 17d for cleaning the individual photoconductive drums 11a to 11d, a transfer roller 19 for transferring the toner image held by the transfer belt 15 onto a sheet medium, a fuser 21 for fixing the toner image transferred to the sheet medium by the transfer roller 19 onto the sheet medium, and an exposing device 23 for forming latent images on the photoconductive drums 11a to 11d.

The first to fourth developers 13a to 13d store toners having optional colors of Y (yellow), M (magenta), C (cyan) and Bk (black) which are used for obtaining a color image by a subtractive process and visualize a latent image held by each of the photoconductive drums 11a to 11d in any of the colors Y, M, C and Bk. The respective colors are determined in predetermined order corresponding to an image forming process or a characteristic of the toner.

The transfer belt 15 holds the toner images having the respective colors which are formed by the first to fourth photoconductive drums 11a to 11d and the corresponding developers 13a to 13d in order (of the formation of the toner images).

The sheet feeder 3 supplies the sheet medium to be transferred the toner image by the transfer roller 19.

Cassettes positioned in a plurality of cassette slots 31 store sheet media having optional sizes. Depending on an image forming operation, a pickup roller 33 takes the sheet medium out of the corresponding cassette. The size of the sheet medium corresponds to a size of the toner image formed by the image forming section 1.

A separating mechanism 35 prevents at least two sheet media from being taken out of the cassette by the pickup roller 33.

A plurality of delivery rollers 37 feed the sheet medium separated to be one sheet medium by the separating mechanism 35 toward an aligning roller 39.

The aligning roller 39 feeds the sheet medium to a transfer position in which the transfer roller 19 and the transfer belt 15 come in contact with each other in a timing for transferring the toner image from the transfer belt 15 by the transfer roller 19.

The fuser 21 includes a first roller 121 which generates heat through the heat of a heater 122, a belt 124 which is hung between a second roller 123 and the first roller 121 after receiving the heat from the first roller 121 and conducts the heat of the first roller 121 to the second roller 123 side, and a third roller 125 which provides a predetermined pressure to the sheet medium moving between the belt 124 and the third roller coming into contact with the belt 124.

A nip is formed on an arbitrary part of the belt 124 and a periphery of the third roller 125 due to the pressure applied to the second roller 123 and the third roller 125. By doing so, on the sheet medium passing through the nip, a temperature (fixing temperature) capable of fusing the toner and the predetermined pressure are applied so as to enable fixing of the toner (the toner image) held by the sheet medium.

The fuser 21 fixes the toner image corresponding to the image information onto the sheet medium as the output image (hard copy, print out) and feeds the output image to a stocker 47 positioned in a space between the scanner section 5 and the image forming section 1.

The fuser unit 21 includes a reversing roller 126 which transports the toner image, held by the sheet medium in an automatic duplexing unit (ADU) 41 for replacing both sides of the sheet medium, corresponding to the image information, to the reversing path 43 of the ADU 41 independently of the operation which transports the output image (hard copy or print out) to a stocker 47.

The ADU 41 moves to a side (a right side) with respect to the image forming section 1, if the sheet medium is jammed between the delivery roller 37 (a final one) and the aligning roller 39 or between the aligning roller 39 and the fuser 21, that is, in the transfer roller 19 or the fuser 21. The ADU 41 integrally has a cleaner 25 for cleaning the transfer roller 19.

A media sensor 45 to detect thickness of the sheet medium conveyed to the aligning roller 39 in the path between the delivery roller 37 and the aligning roller 39. The media sensor 45 useable an optical type benefit of priority from: U.S. patent application Ser. Nos. 12/197,880 filed on Aug. 25, 2008 and 12/199,424 filed on Aug. 27, 2008 and/or a shift of thickness detecting roller type benefit of priority from: U.S. Provisional Application No. 61/043,801 filed on Apr. 10, 2008, each of which are incorporated.

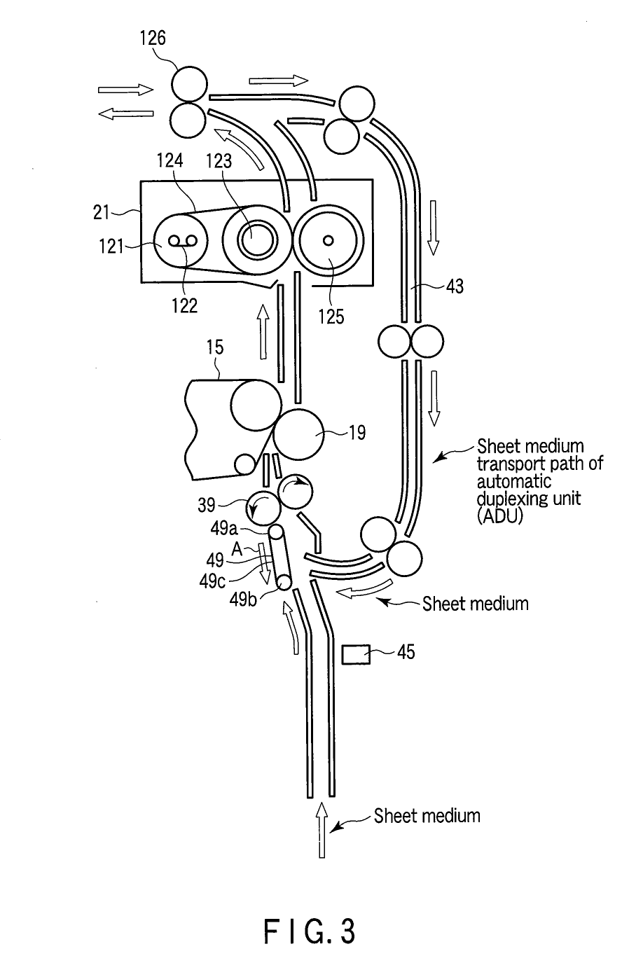

As shown in FIG. 3, the leading edge of the sheet medium transported on the reversing path 43 is guided by a movable guide (guide mechanism) 49 positioned between a delivery roller 37 (the final one) and the aligning roller 39.

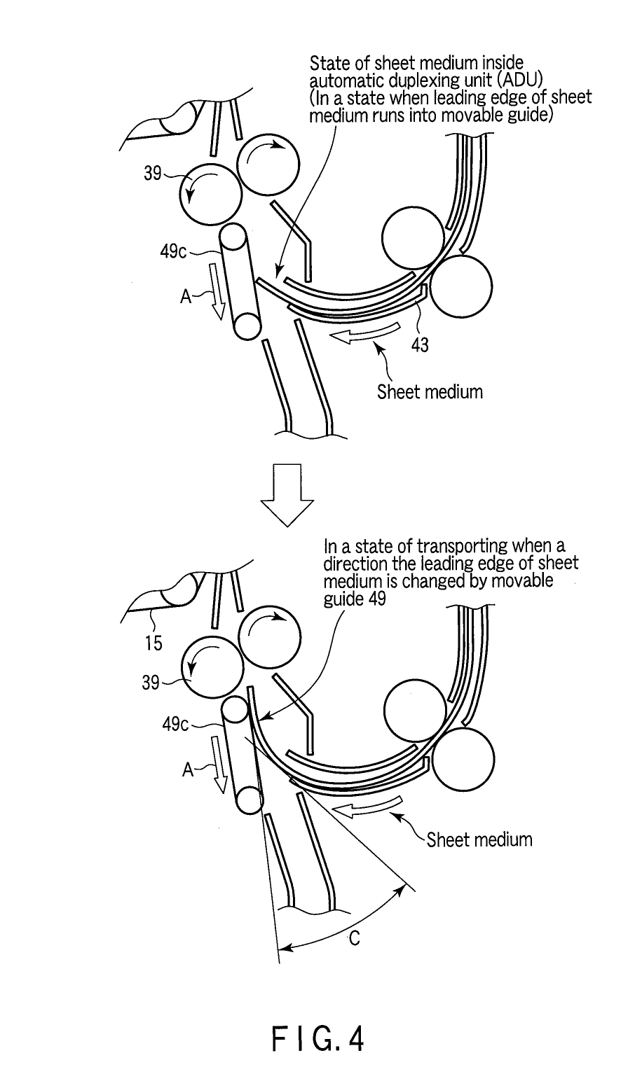

The movable guide 49 includes at least a belt 49c which is hung between a first roller 49a positioned at the aligning roller 39 side and a second roller 49b positioned at the delivery rollers 37 side (the final one) and the belt surface of the belt 49c is transported in the direction of the arrow A, when the leading edge of the sheet medium reaches the movable guide (refer to FIG. 4).

As a result, the sheet medium (which is transported on the reversing path 43) can be prevented from becoming struck (a jam occurs) in the neighboring area of the aligning roller 39, even when the weight per one square meter (g/m²) to denote the thickness of the sheet medium exceeds, for example, 200 g/m². In addition, since the sheet medium (which is transported on the reversing path 43) is easily transported to the aligning roller 39, fluctuations in the transport velocity of the sheet medium is suppressed.

In particular, when the angle C formed by the terminal edge of the reversing path 43 and the belt surface 49c of the movable guide 49 with respect to the belt surface 49 c of the movable guide 49 (the path between the delivery rollers 37 (the final one) and the aligning roller 39) exceeds more than 60°. Since, the path between the delivery rollers 37 and the aligning roller 39 has a large entrance angle from the reversing path 43 to the aligning roller 39, it is preferable to prepare a transport path in which passing a path having the large curvature and when the weight per one square meter of the sheet medium exceeds 200 g/m², so as to reduce the size of neighboring area of the ADU 41. In a case when, it is preferable to prepare a transport path in which passing a path not having a small entrance angle with the path between the delivery rollers 37 and the aligning roller 39 has a large curvature from the reversing path 43 to the aligning roller 39 formed by the terminal edge of the reversing path 43.

That is, the movable guide 49 does not need the path not having the small entrance angle (with the path between the delivery rollers 37 and the aligning roller 39) has the large curvature (from the reversing path 43 to the aligning roller 39) which is necessary in the neighboring area of the aligning roller 39 of the reversing path 43 (to the reversing path 43) and for easily guiding the leading edge of the sheet medium to the path between the delivery rollers 37 (the final one) and the aligning roller 39.

In addition, it is also preferable to secure friction resistance of the belt surface 49c to fixed degree or greater in order to suppress the sliding of the leading edge of the sheet medium which reaches the belt surface 49c.

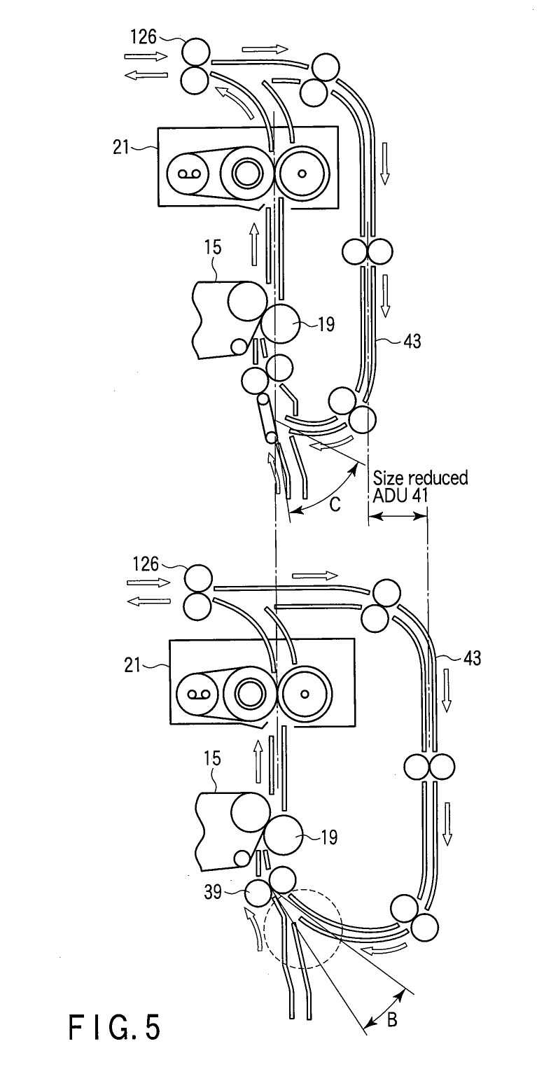

By using the above described movable guide 49, the stocker 47 which supports the sheet medium holding the output image is disposed so that the longitudinal direction of the largest sheet medium having capable of being output and the width direction of the MFP 1 are coincident. In this case, as shown in FIG. 1, the entire width of the MFP1 where ADU 41 is integrated, can be suppressed to approximately “1.4 L” when the length of the sheet medium is “L”. That is, since the “L” is 420 mm in A3 sheet and is approximately 432 mm in the sheet size of “11×17”, “1.4 L” is approximately 60 cm. In addition, as shown in FIG. 5, in the neighboring area of the aligning roller 39, it is possible to reduce the size of the neighboring area of the ADU 41 as compared to an example where the reversing path 43 is configured to have a large curvature so that, the angle B is less than 30°.

Further, when the leading edge of the sheet medium run into the path by rotating any one of the first roller and the second roller of the movable guide 49, for example, with a motor which provides rotation to the aligning roller 39, it is possible to easily transport the change a direction of the resistance which occurs on the leading edge of the sheet medium for easily transport (of the sheet medium), that is, the power of interrupting the transport of the leading edge of the sheet medium.

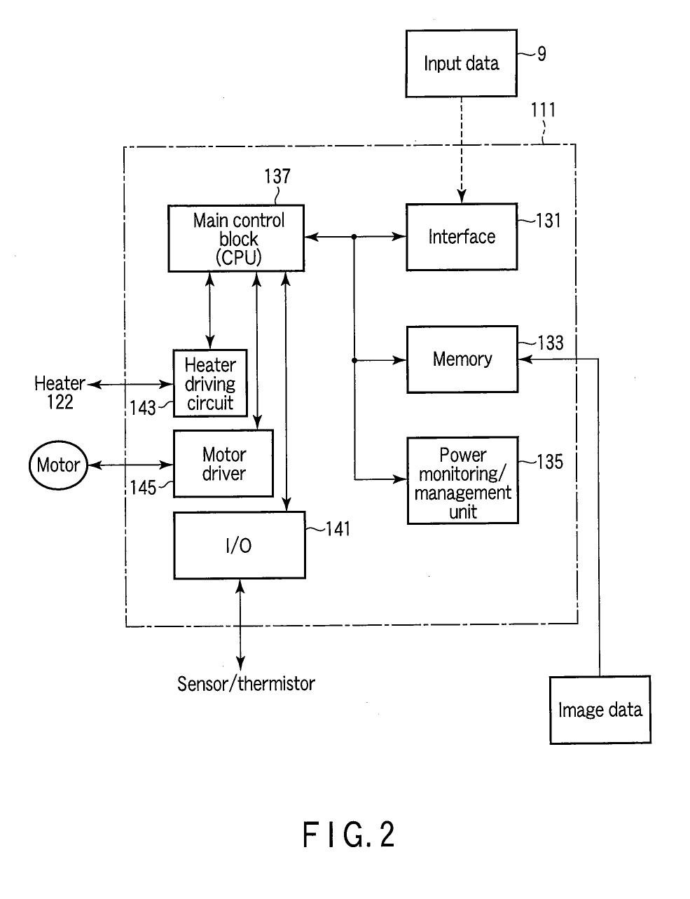

As shown in FIG. 2 as an example, the control unit 111 includes an interface 131 which receives input values from the control panel (an operation unit) 9 capable of being input such as the number of the output image (output) sheets which corresponds to the image information obtained by the scanner section 5 (and the ADF 7), output image magnifications, the size of the sheet medium (size), a printing starting signal and the like, a memory 133 which stores the input numerical data (input value) or an activation program upon warming up, a power monitoring/management unit 135 and a main control block (CPU) 137 which control the upper limit of the usable power for increasing the fixing temperature (of the fixing belt of the fuser 21) depending on the temperature conditions of the fuser 21 and the like, and the types of sheet medium which are detected by the media sensor 45. In addition, the CPU (main control block) 137 sets the power which is supplied from a heater driving circuit 143 to the heater (of the fuser 21) via an input and output section 141, in accordance with the fixing temperature (of the fixing belt and the pressure roller of the fuser 21) obtained from a temperature sensor (a thermistor). The maximum value of the power capable of being supplied to the heater is the upper limit of the usable power in which the power monitoring/management unit 135 can control. Additionally, when exceeding a predetermined thickness of the sheet medium which is detected by the media sensor 45 and transporting the sheet medium to the aligning roller 39 once again by the ADU 41, the CPU 137 causes the rotations of the motor which rotates the first roller or the second roller of the movable guide 49 at a predetermined timing, by the motor driver 145.

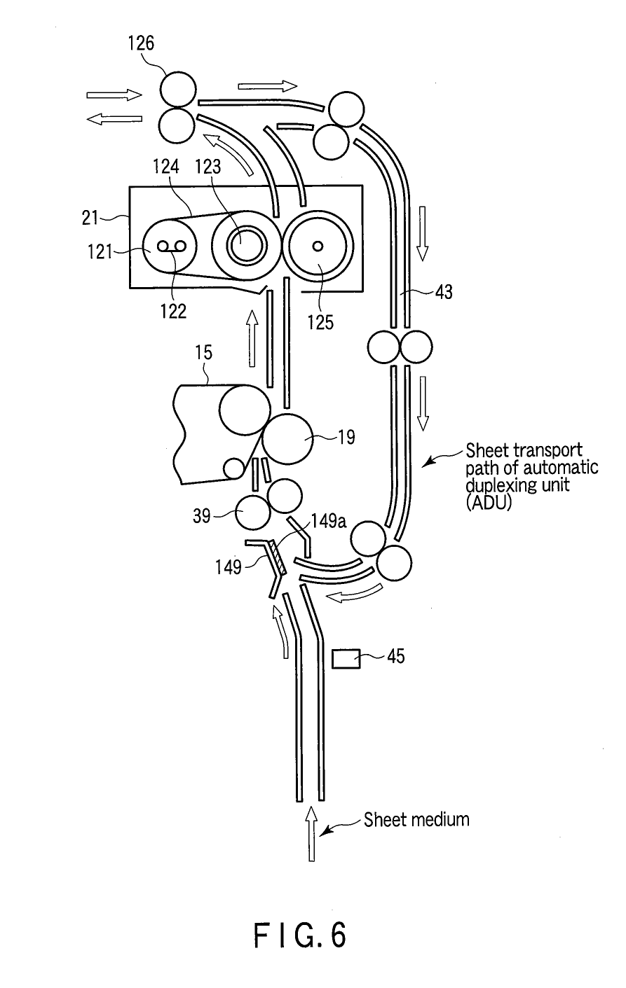

Moreover, as shown in FIG. 6 as an example, when the leading edge of the sheet medium is transported to the path between the delivery rollers 37 (the final one) and the aligning roller 39 by reducing the friction resistance of the surface, so as to suppress the occurrence of the power of interrupting the transport of the leading edge of the sheet medium, a stationary type guide mechanism (guide mechanism) 149 may be provided. Also as a method for reducing the friction resistance of the surface, for example, it is preferable to dispose a tetrafluoroethylene resin or a fluorine resin on the surface, with which the leading edge of the sheet medium which is a base material of the guide mechanism 149 comes in contact, as a release layer 149c.

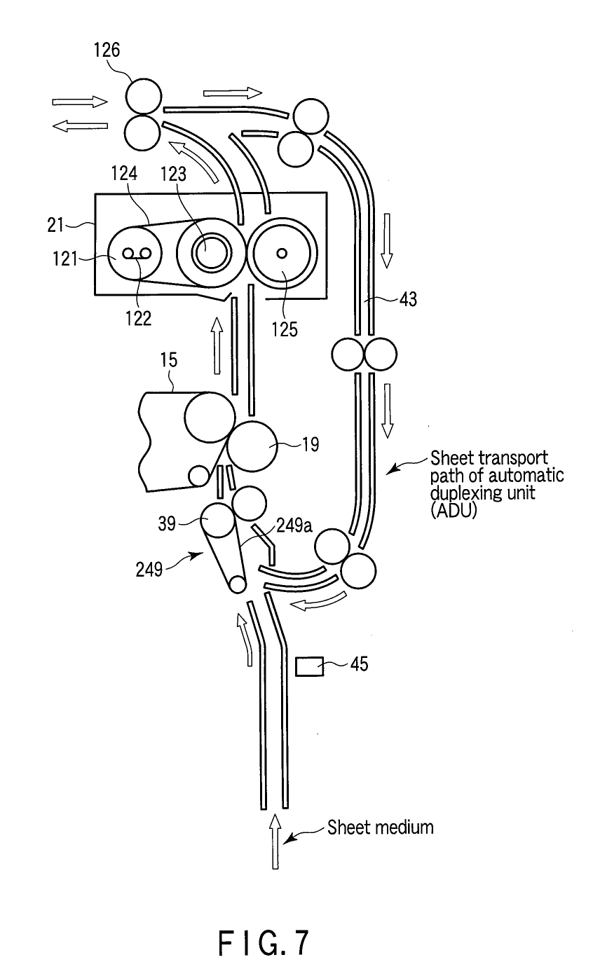

As shown as an example in FIG. 7, it is also possible to reduce the space where the movable guide is installed, by means using in common the aligning roller and any one of the rollers of the movable guide to be used as an aligning and movable guide (guide mechanism) 249.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A parrying structure around sheet junction comprising:
a first transporting guide that guides a sheet medium;
a second transporting guide that guides the sheet medium toward the first transporting guide at a larger angle than a predetermined angle with respect to a direction where the sheet medium is guided by the first transporting guide; and
a third transporting guide that changes a direction of a leading edge of the sheet medium and guides by the second transporting guide and moved to the first transporting guide, toward the first transporting guide.

2. The structure of claim 1, wherein the third transporting guide applies thrust force to the sheet medium guided by the second transporting guide so as to head for the first transporting guide.

3. The structure of claim 1, wherein a part of the third transporting guide is moved toward the first transporting guide by the thrust force of the sheet medium guided by the second transporting guide.

4. The structure of claim 3, wherein the third transporting guide includes a belt surface moving to the first transporting guide side and a movement of a part of the third transporting guide includes the movement of the belt surface.

5. The structure of claim 4, wherein the movement of the belt surface includes the movement at a predetermined timing independent of the movement of the sheet medium guided by the second transporting guide.

6. The structure of claim 3, wherein the belt surface includes a higher friction surface which suppresses a slip of the sheet medium.

7. The structure of claim 1, wherein the third transporting guide includes a lower friction surface which converts the thrust force of the sheet medium guided by the second transporting guide into the thrust force in which the sheet medium itself heads for the first transporting guide.

8. The structure of claim 7, wherein the lower friction surface includes a fluorine resin.

9. A method to guide a sheet medium comprising:
directing a sheet medium to a transporting guide at a larger angle than a predetermined angle with respect to a direction where the sheet medium is guided by a transporting guide; and
guiding a leading edge of the sheet medium so that the leading edge of the sheet medium which moves toward the transporting guide may be along a direction where the sheet medium is guided by the transporting guide.

10. An image forming apparatus comprising:
a transfer device that transfers an image formed by a visualizing agent on a sheet medium;
a first transporting guide that guides the sheet medium to the transfer device;
a second transporting guide that guides the sheet medium toward the first transporting guide at a larger angle than a predetermined angle with respect to a direction where the sheet medium is guided by the first transporting guide; and
a third transporting guide that guides a leading edge of the sheet medium, which is guided by the second transporting guide and moved to the first transporting guide, toward the first transporting guide.

11. The apparatus of claim 10, wherein the third transporting guide changes a direction of the sheet medium and applies thrust force to the sheet medium guided by the second transporting guide so as to head for the first transporting guide.

12. The apparatus of claim 10, wherein a part of the third transporting guide is moved toward the first transporting guide by the thrust force of the sheet medium guided by the second transporting guide.

13. The apparatus of claim 12, wherein the third transporting guide includes a belt surface moving to the first transporting guide side and a movement of a part of the third transporting guide includes the movement of the belt surface.

14. The apparatus of claim 13, wherein the movement of the belt surface includes the movement at a predetermined timing independent of the movement of the sheet medium guided by the second transporting guide.

15. The apparatus of claim 10, wherein the third transporting guide includes a lower friction surface which converts the thrust force of the sheet medium guided by the second transporting guide into the thrust force in which the sheet medium itself heads for the first transporting guide.

16. The apparatus of claim 10, wherein the lower friction surface includes a release layer.

17. The apparatus of claim 16, wherein the release layer includes a fluorine resin.

18. The apparatus of claim 10, further comprising:
a fuser that fixes an image transferred by the transfer device on the sheet medium; and
a reversing device that guides the sheet medium, on which the fuser fixes the image, to the second transporting guide.

19. The apparatus of claim 18, wherein the third transporting guide changes a direction of the sheet medium and applies force to the sheet medium guided by the second transporting guide so as to head for the first transporting guide.

20. The apparatus of claim 18, wherein a part of the third transporting guide is moved toward the first transporting guide by the thrust force of the sheet medium guided by the second transporting guide.
